(19) United States
(12) Patent Application Publication
(10) Pub. No.: US 2025/0199309 A1
(43) Pub. Date: Jun. 19, 2025

(54) HEAD-UP DISPLAY DEVICE

(71) Applicant: Nippon Seiki Co., Ltd., Niigata (JP)

(72) Inventors: Maiko Saito, Niigata (JP); Ayako Fujita, Niigata (JP)

(21) Appl. No.: 18/953,399

(22) Filed: Nov. 20, 2024

(30) Foreign Application Priority Data
Dec. 19, 2023 (JP) 2023-213466

(51) Int. Cl. G02B 27/01

(52) U.S. Cl. CPC G02B 27/0149; G02B 27/0101; G02B 2027/015

(57) ABSTRACT

To reflect a light beam emitted from a light source without deteriorating display quality and thus to downsize a device. A head-up display device allowing at least a real image to be visually recognized, that includes a first light source, a first display displaying the real image, and a reflector reflecting a first light beam representing the real image toward a windshield. The reflector reflects the first light beam by a first mirror, a second mirror and a third mirror in this order. The first mirror is disposed, along an optical path of the first light beam, closer to an opening than the first display as well as to the first display than a first optical focus of an imaging optical system that includes the windshield, second mirror and third mirror. A height position of the third mirror is above a height position of the first display.

### TECHNICAL FIELD

The present invention relates to a head-up display device that performs desired display for a viewer.

### BACKGROUND ART

Conventionally, a head-up display device has been known, as described in, e.g., Patent Document 1. The head-up display device defined above is configured so that a display image displayed on a screen based on light from a display unit is reflected toward a light-transmissive member, wherein display modes are switched between a state in which a virtual image is visually recognized outside the light-transmissive member and a state in which a real image is visually recognized inside the light-transmissive member by changing a front-rear positional relationship between an optical focus of an imaging optical system and the screen.

### PRIOR ART DOCUMENT

### Patent Document

Patent Document 1: Japanese Unexamined Patent Publication No. 2011-070074.

### SUMMARY OF INVENTION

### Technical Problem

However, in the above-described conventional head-up display device, in order for the viewer to recognize the real image, it is necessary to make a distance between an object to be viewed and an imaging optical system of real specular image longer than a distance between a front window as a reflective member and the imaging optical system of real specular image, which may increase in size a housing of the head-up display device.

In addition, a structural configuration of a vehicle body should be considered when a layout for installing the head-up display device is designed, but increasing in size the housing would make it very difficult to design the layout.

In view of the above situation, the present invention is to provide a head-up display device capable of reflecting a light beam emitted from a light source without deteriorating display quality and thereby ensuring downsizing of the device.

### Solution to Problem

The present invention provides a head-up display device provided with an emission port 17 and emitting display light from the emission port 17 toward a light-transmissive member WS so as to allow at least a real image RI of a display image represented by the display light to be visually recognized, the head-up display device comprising: a first display provided with a first display element, the first display 12a transmitting light emitted from a real-image first light source 11a and displaying the real image RI of the display image; and a reflector reflecting at least a first light beam L1 representing the real image RI displayed on the first display 12a toward the light-transmissive member WS, the reflector including: a first mirror 131 reflecting the first light beam L1 toward a second mirror 132; the second mirror 132 reflecting the first light beam L1 toward a third mirror 133; and the third mirror 133 reflecting the first light beam L1 toward the emission port 17, wherein the first mirror 131 is disposed, along an optical path of the first light beam L1, closer to the emission port 17 than the first display 12a as well as to the first display 12a than a first optical focus of an imaging optical system that includes the light-transmissive member WS, the second mirror 132 and the third mirror 133, and wherein the third mirror 133 and the first display 12a are disposed so that at least a height position of the third mirror 133 is above a height position of the first display 12a.

### Advantageous Effects of Invention

According to the present invention, a light path, in which the light emitted from the light source is transmitted through the first display, is reflected by the first mirror, is condensed at a position of the first optical focus, is reflected by the second mirror and the third mirror, and travels to the emission port, is realized. In the configuration for realizing the light path, it is possible to arrange the essential components in a substantially “U” shape, and thus to achieve the downsizing of the device.

Further, the first mirror is disposed closer to the first display than the position of the first optical focus, so that it is possible to display the real image at an arbitrary position.

Yet further, although the farther the position of the first optical focus is from the second mirror, the closer the real image is to an occupant and the harder it is to view, positioning the first optical focus between the first mirror and the second mirror makes it possible to shift the position of the first optical focus as close to the second mirror as possible and thus to allow the occupant to more easily view the real image.

Furthermore, in a case where the first mirror is disposed in the vicinity of the position of the first optical focus, the size of the first mirror itself can be reduced, which makes it possible to downsize the device.

### BRIEF DESCRIPTION OF DRAWINGS

FIG. 1 is a diagram depicting a configuration of a head-up display device according to a first embodiment of the present invention, in a case where a real image is displayed.

FIG. 2 is a diagram depicting a configuration of the head-up display device according to the first embodiment of the present invention, in a case where a first mirror is a plane mirror.

FIG. 3A is a schematic diagram depicting a mode of a first light beam in a case where a first mirror is disposed close to a first optical focus, and

FIG. 3B is a schematic diagram depicting a mode of the first light beam in a case where the first mirror is disposed away from the first optical focus, both in the head-up display device according to the first embodiment of the present invention.

FIG. 4A is a schematic diagram depicting a positional relationship between respective mirrors and a first optical focus in a case where the first optical focus is close to the first mirror, and FIG. 4B is a schematic diagram depicting a positional relationship between respective mirrors and a first optical focus in a case where the first optical focus is close to the second mirror, both in the layout configuration of the first mirror and the second mirror depicted in FIG. 3B.

FIG. 5 is a diagram depicting a configuration of a head-up display device according to a second embodiment of the present invention, in a case where a virtual image or a real image is displayed.

### DESCRIPTION OF EMBODIMENTS

### First Embodiment of the Present Invention

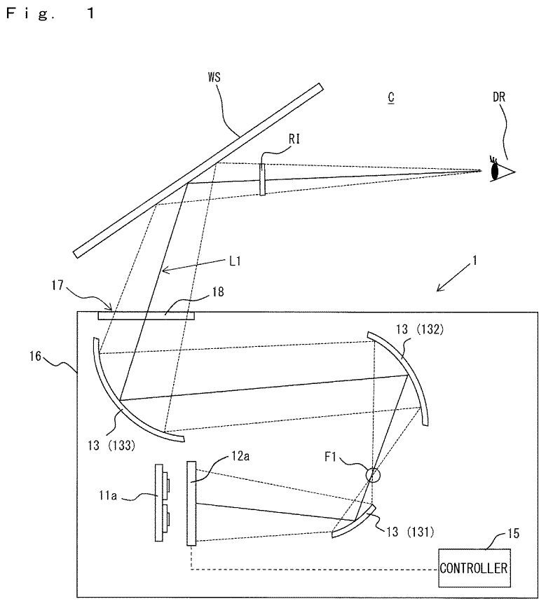

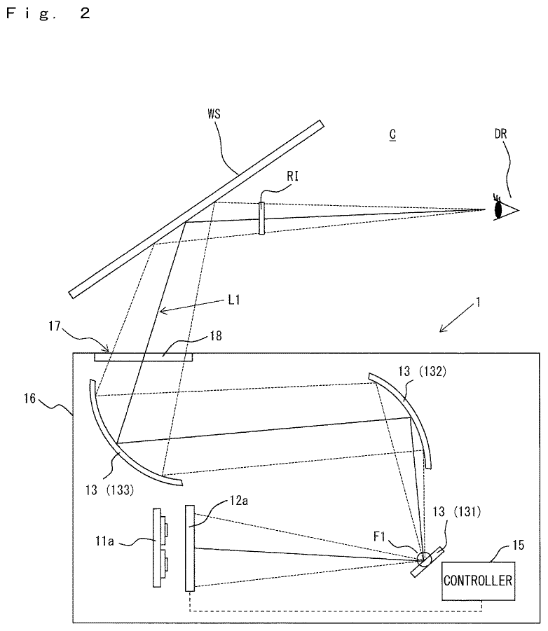

A head-up display device (hereinafter referred to as an HUD device) according to the present embodiment will be described with reference to FIGS. 1 to 4B. The HUD device 1 according to the present embodiment displays a real image RI in front of an occupant DR driving a vehicle C and at an inner side of the vehicle, i.e., inside a windshield WS.

FIG. 1 is a diagram depicting a configuration of the HUD device 1 according to the present embodiment in a case where the real image RI is displayed. In FIG. 1, the HUD device 1 includes a first light source 11a that emits light in, e.g., visible wavelength range, a first display 12a that transmits the light emitted from the first light source 11a and displays the real image RI of a display image formed in front of the occupant DR, a reflector 13 that reflects a first light beam L1 representing the display image displayed on the first display 12a toward the windshield WS (or light-transmissive member), and a controller 15 that controls the contents of display in the first display 12a, all of which are contained in a housing 16. The housing 16 is provided with an opening 17 (or emission port) through which the first light beam L1 is emitted, and a cover glass 18 for protecting the interior of the housing is disposed in the opening 17. The windshield WS is an example of a light-transmissive member, and the opening 17 is an example of an emission port.

Note that an infinite number of light beams are actually emitted from the first display 12a, but in FIG. 1, a light beam emitted from the center of the first display 12a and passing through the center of an eye box is depicted as the first light beam L1 as a representative light beam.

The HUD device 1 is disposed below the windshield WS (e.g., inside an instrument panel) of the vehicle C, emits the first light beam L1 and projects it on the windshield WS. The first light beam L1 is generated by the first light source 11a and the first display 12a, both provided within the HUD device 1. The first light beam L1 emitted from the first display 12a travels along the reflector 13 and is emitted from the opening 17 of the housing 16 through the cover glass 18. The occupant DR in the vehicle C views the first light beam L1 reflected by the windshield WS, and thus is able to visually recognize the real image RI as depicted in FIG. 1 at the inner side of the vehicle, i.e., inside or on the near side of the windshield WS as seen from the occupant DR.

As examples of the real image RI depicted in FIG. 1, entertainment contents, an assistant or agent supporting the occupant DR, a character indicating the assistant or agent, etc., are displayed on the near side of the windshield WS as seen from the occupant DR. Such display properties provide a driving environment in which needs for viewpoint movement and eye focal-length adjustment are reduced. The real image RI also includes a background part in addition to characters or icons indicating the above-described information, the background part having, e.g., a substantially rectangular shape in a plan view as seen from the occupant DR.

In FIG. 1, the first light source 11a is, e.g., a light-emitting diode mounted on a circuit board and emitting light in the visible-wavelength range, which emits white light. The first display 12a is arranged closer to the opening 17 than the first light source 11a along an optical path, and includes a first display element (Same figure as The first display 12a) of a thin film transistor (TFT) type that forms light representing an arbitrary image in accordance with a control signal sent from the controller 15.

The reflector 13 includes a first mirror 131 reflecting the first light beam L1 emitted from the first display 12a toward a second mirror 132, the second mirror 132 reflecting the first light beam L1 toward a third mirror 133, and the third mirror 133 reflecting the first light beam L1 toward the opening 17 as the emission port.

As depicted in FIG. 1, the first mirror 131 is disposed at a position with substantially the same height as positions of the first light source 11a and the first display 12a, and reflects the first light beam L1 emitted in a generally horizontal direction from the first display 12a toward in a generally vertical direction the second mirror 132 disposed above the first mirror 131. In this connection, the “height” in the present disclosure means a distance in an up-down or vertical direction in FIG. 1, and also in an up-down or vertical direction of the vehicle C. The second mirror 132 reflects the first light beam L1 from the generally vertical direction reflected by the first mirror 131, toward in a generally horizontal direction the third mirror 133 disposed at a position with substantially the same height as the position of the second mirror 132. The third mirror 133 is disposed at a position above the positions of the first light source 11a and the first display 12a, and reflects the first light beam L1 from the generally horizontal direction reflected by the second mirror 132 toward the opening 17 above the third mirror 133. Then, the first light beam L1 reflected by the third mirror 133 is emitted to the windshield WS through the cover glass 18, and the occupant DR visually recognizes the display image represented by the first light beam L1 as the real image RI.

The first mirror 131 is disposed, along the optical path of the first light beam L1, closer to the opening 17 than the first light source 11a and the first display 12a, as well as to the first display 12a than a first optical focus F1 of an imaging optical system that includes the windshield WS, the second mirror 132 and the third mirror 133.

The above-described positional relationship between the first light source 11a, the first display 12a and the reflector 13 provides the optical path of the first light beam L1 in a substantially “U” shape, and makes it possible to downsize the housing 16. Further, since the first optical focus F1 is located closer to the opening 17 than the first mirror 131, it is possible to display the real image RI at any appropriate positions in front of the occupant DR. In this connection, if the first optical focus F1 is located closer to the first display 12a than the first mirror 131, the first optical focus F1 is being spaced from the second mirror 132, and the real image RI becomes displayed at a position gradually closer to the occupant DR in a larger size in accordance with spacing degrees, which makes the real image RI very difficult to view for the occupant DR. Thus, it is preferable that the first optical focus F1 is near the second mirror 132, and in the HUD device 1 according to the present embodiment, the reflector 13 is arranged in such a manner that the first optical focus F1 is positioned at least between the first mirror 131 and the second mirror 132 as depicted in FIG. 1.

In FIG. 1, the first mirror 131 and the second mirror 132 may be concave mirrors having free-form surfaces, so as to correct distortion and/or blurring of the real image RI while enlarging the real image RI represented by the first light beam L1, and also the third mirror 133 may be a concave mirror so as to enlarge the real image RI. Such a configuration makes it possible to display the real image RI with high display quality.

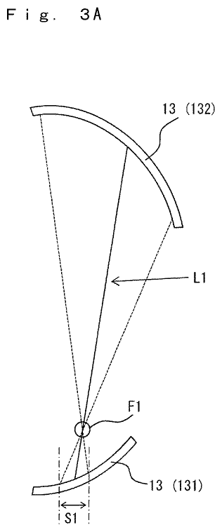

Further, the first mirror 131 may be a mirror having a planar shape or a convex shape. FIG. 2 is a diagram depicting a configuration of the HUD device 1 according to the present embodiment, in a case where the first mirror 131 is a plane mirror. As described above, in the case where the first mirror 131 is a concave mirror having a free-form surface, the distortion and/or blurring of the real image RI is corrected by the first mirror 131 and the second mirror 132, and thereby the display quality can be improved. However, if the second mirror 132 and the third mirror 133 can sufficiently ensure the display quality, e.g., when both of the second mirror 132 and the third mirror 133 are concave mirrors with free-form surfaces and thereby ensure the sufficient display quality, the first mirror 131 may be required to simply reflect the first light beam L1 from the horizontal direction to the vertical direction, and therefore it becomes possible to use the plane mirror as depicted in FIG. 2 (or convex mirror, as needed). In this case, since the plane mirror merely reflects the first light beam L1, the position and/or incident angle of the mirror do not affect the display quality. Based on the above, as depicted in FIG. 2, the first mirror 131 is disposed so as to reflect the first light beam L1 at a position of the first optical focus F1 (i.e., the first optical focus F1 is positioned directly on the reflecting surface of the first mirror 131), which makes it possible to significantly reduce the size of the first mirror 131 and thus to downsize the housing 16 accordingly.

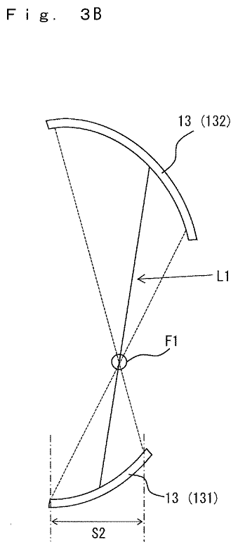

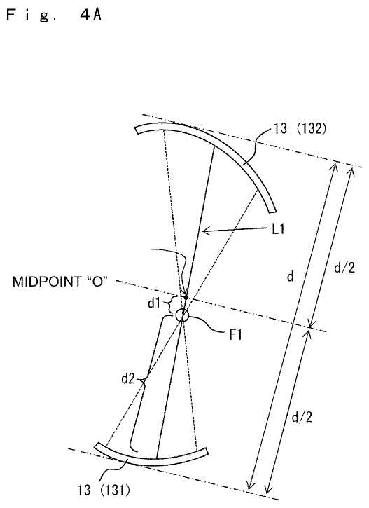

As discussed previously, it is preferable that the first optical focus F1 is near the second mirror 132 from the viewpoint of the displaying position of the real image RI. In addition, from the viewpoint of improving the display quality by correction properties, it is preferable that the first mirror 131 is disposed at a position as far as possible from the first optical focus F1. FIG. 3A is a schematic diagram depicting a mode of the first light beam L1 in a case where the first mirror 131 is disposed close to the first optical focus F1, and FIG. 3B is a schematic diagram depicting a mode of the first light beam L1 in a case where the first mirror 131 is disposed away from the first optical focus F1, both in the HUD device 1 according to the present embodiment. In FIGS. 3A and 3B, components other than the first mirror 131 and the second mirror 132 are omitted.

In FIG. 3A, when the first mirror 131 is disposed close to the first optical focus F1, a correction area S1 on the first mirror 131 becomes narrow, and therefore the number of light beams per unit area increases. In other words, provided that magnification ratio for enlargement is identical, it is required to correct a plurality of light beams in the narrow correction area S1, which makes it difficult to sufficiently ensure the display quality. On the other hand, in FIG. 3B, a correction area S2 on the first mirror 131 becomes wide, and thus the number of light beams per unit area decreases. In other words, provided that magnification ratio for enlargement is identical, it is possible to correct a plurality of light beams in the wide correction area S2, and thus to improve the display quality.

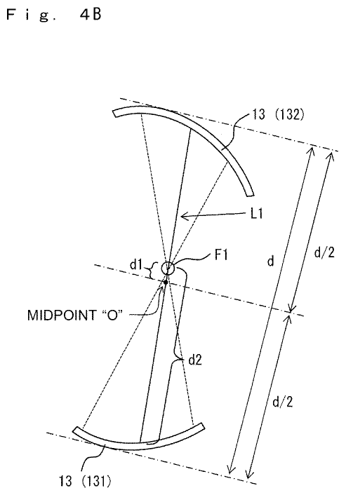

FIGS. 4A and 4B are schematic diagrams depicting a positional relationship between respective mirrors and the first optical focus F1, both in the layout configuration of the first mirror 131 and the second mirror 132 depicted in FIG. 3B. In FIGS. 4A and 4B, in which a midpoint positioned at half a maximum distance “d” between the first mirror 131 and the second mirror 132 is denoted by “O”, a distance between the midpoint O and the first optical focus F1 is denoted by “d1”, and a distance between the first mirror 131 and the first optical focus F1 is denoted by “d2”, the first mirror 131 and the second mirror 132 are disposed so as to ensure the relationship of d1≤d2 (d1 equal to or less than d2). FIG. 4A depicts a case where the first optical focus F1 is positioned closer to the first mirror 131 than the midpoint O, and FIG. 4B depicts a case where the first optical focus F1 is positioned closer to the second mirror 132 than the midpoint O. In either case, the first mirror 131 and the second mirror 132 are disposed in the d1≤d2 relationship, so that it is possible to perform appropriate correction adaptive to the respective configurations, as depicted in FIG. 3B, and thus to improve the display quality.

The controller 15 controls the first display element of the first display 12a so as to generate, e.g., the first light beam L1 representing a display image such as entertainment contents, an assistant or agent supporting the occupant DR, a character indicating the assistant or agent, etc., as discussed previously. The first light beam L1 generated by the first display element forms the real image RI in front of the occupant DR while being enlarged and corrected through the reflector 13, as discussed previously.

Note that it is enough at least one of the first mirror 131, the second mirror 132 and the third mirror 133 included in the reflector 13 is a mirror having a free-form surface. However, when plural mirrors are shaped to have free-form surfaces, the quality of correction is improved, which makes it possible to significantly improve the display quality.

As described above, the HUD device 1 according to the present embodiment is configured to include the first display 12a provided with the first display element, which transmits light emitted from the first light source 11a for real image RI and displays the real image RI of a display image; and the reflector 13 that reflects at least the first light beam L1 representing the real image RI displayed on the first display 12a toward the windshield WS, in which the reflector 13 includes the first mirror 131 reflecting the first light beam L1 toward the second mirror 132; the second mirror 132 reflecting the first light beam L1 toward the third mirror 133; and the third mirror 133 reflecting the first light beam L1 toward the opening 17, wherein the first mirror 131 is disposed, along the optical path of the first light beam L1, closer to the opening 17 than the first display 12a as well as to the first display 12a than the first optical focus F1 of the imaging optical system that includes the windshield WS, the second mirror 132 and the third mirror 133, and wherein the third mirror 133 and the first display 12a are disposed so that at least the height position of the third mirror 133 is above the height position of the first display 12a. According to the above configuration, a light path is realized, in which the light emitted from the first light source 11a is transmitted through the first display 12a, is reflected by the first mirror 131, is condensed at the first optical focus F1, is reflected by the second mirror 132 and the third mirror 133, and travels to the opening 17, and, in the configuration for realizing the light path, it is possible to arrange the essential components in a substantially “U” shape, and thus to achieve the downsizing of the HUD device 1.

Further, the position of the first optical focus F1 is disposed closer to the opening 17 than the first mirror 131, so that it is possible to display the real image RI at an arbitrary position.

Yet further, although the farther the position of the first optical focus F1 is from the second mirror 132, the closer the real image RI is to the occupant DR and the harder it is to view, positioning the first optical focus F1 between the first mirror 131 and the second mirror 132 makes it possible to shift the position of the first optical focus F1 as close to the second mirror 132 as possible and thus to allow the occupant DR to more easily view the real image RI.

Furthermore, when the first mirror 131 is disposed in the vicinity of the first optical focus F1, the size of the first mirror 131 itself can be reduced, which makes it possible to downsize the HUD device 1.

Still further, provision of the second mirror 132 as the concave mirror having the free-form surface ensures image correction effects due to the free-form surface, which makes it possible to improve the display quality.

Moreover, when the first mirror 131 is the plane mirror and the first optical focus F1 is positioned on the first mirror 131, it is possible to sufficiently improve the display quality only by the second mirror 132 and the third mirror 133, provided that, e.g., the third mirror 133 is the concave mirror having the free-form surface. Therefore, the first mirror 131 can be the plane mirror. In this case, positioning the first optical focus F1 on the first mirror 131 makes it possible to reduce the size of the first mirror 131, and thus to further downsize the HUD device 1 in its entirety.

Even further, provision of the first mirror 131 as the concave mirror having the free-form surface and positioning the first optical focus F1 between the first mirror 131 and the second mirror 132 along the optical path of the first light beam L1 ensure some advantageous effects. For example, when a virtual image is to be displayed as described later in the second embodiment, it is required for the third mirror 133 to perform correction for displaying the virtual image, which makes it impossible to use the third mirror 133 as a correction mirror useful in a real-image displaying. Thus, the configuration in which the first mirror 131 performs correction with the free-form surface thereof makes it possible to ensure the display quality when carrying out the real-image displaying. In this configuration, particularly when the first mirror 131 is spaced away from the position of the first optical focus F1, it is possible to surely widen a correction area S1, S2 in the first mirror 131, and thus to further improve the display quality.

### Second Embodiment of the Present Invention

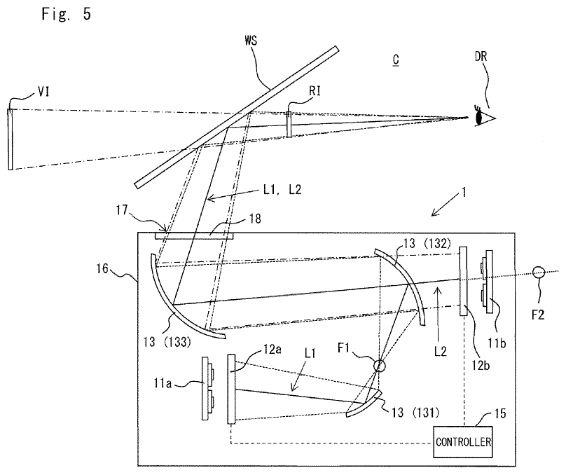

The HUD device according to the present embodiment will be described with reference to FIG. 5. The HUD device 1 according to the present embodiment displays a virtual image VI at an outer side of the vehicle with the interposition of the windshield WS, in addition to the configuration of the HUD device 1 according to the first embodiment. Note that descriptions regarding the present embodiment, which overlap the descriptions of the first embodiment, will be omitted.

FIG. 5 is a diagram depicting a configuration of the HUD device 1 according to the present embodiment, in a case where the virtual image VI or the real image RI is displayed. In FIG. 5, in addition to the configuration of FIG. 1, the HUD device 1 further includes a second light source 11b and a second display 12b. The second light source 11b is, e.g., a light-emitting diode mounted on a circuit board and emitting light in visible-wavelength range, which emits white light. The second display 12b is arranged closer to the opening 17 than the second light source 11b along an optical path, and includes a second display element (Same figure as The second display 12b) of a TFT type that forms light representing an arbitrary image in accordance with a control signal sent from the controller 15. The second display 12b transmits light emitted from the second light source 11b, and displays the virtual image VI of the display image formed at the vehicle outer side with the interposition of the windshield WS. In FIG. 5, the first light beam L1 and a second light beam L2 are depicted by solid lines, light beams representing the display image of the real image RI associated with the first light beam L1 are depicted by dotted lines, and light beams representing the display image of the virtual image VI associated with the second light beam L2 are depicted by dash-dotted lines.

In FIG. 5, the second mirror 132 is a half mirror, and transmits the second light beam L2 representing the virtual image VI displayed on the second display 12b. The second light beam L2 transmitted through the second mirror 132 is reflected by the third mirror 133 and emitted toward the windshield WS. The second display 12b is disposed, along the optical path of the second light beam L2, closer to the opening 17 than the position of a second optical focus F2 of the imaging optical system that includes the windshield WS, the second mirror 132 and the third mirror 133. According to the above configuration, in a case where the first light source 11a is lit, the occupant DR is able to visually recognize the real image RI at the vehicle inner side and inside the windshield WS, while in a case where the second light source 11b is lit, the occupant DR is able to visually recognize the virtual image VI at the vehicle outer side with the interposition of the windshield WS.

In the virtual image VI depicted in FIG. 5, information highly necessary to call attention to the occupant DR is displayed, which includes, e.g., vehicle information such as the speed or engine revs of the vehicle C, routing assistance such as turn-by-turn or a map, a blind spot indicator, a warning such as a speed limit excess warning, etc.

The second mirror 132 is not limited to a half mirror, and may be any mirror that reflects the first light beam L1 on one surface and transmits the second light beam L2 incident from another surface. For example, a wavelength-selective film may be attached to the mirror, or a transmissive member with a coating may be used.

In the HUD device 1 depicted in FIG. 5, the imaging optical system that generates the virtual image VI is formed only by the windshield WS and the third mirror 133, whereby a concave mirror of the third mirror 133 is provided with high magnification ratio for enlargement. Further, the third mirror 133 has a free-form surface to ensure the display quality of the virtual image VI, and is used as a correction mirror in displaying the virtual image VI. In this case, the third mirror 133 cannot be used as a correction mirror in displaying the real image RI. Therefore, the second mirror 132 is formed as a concave mirror having a free-form surface and is used as a correction mirror in displaying the real image RI. If sufficient display quality cannot be ensured only by the second mirror 132, the first mirror 131 may also be formed as a concave mirror having a free-form surface and used as a correction mirror in displaying the real image RI. On the other hand, as described in the first embodiment, when only the real image RI is displayed, the third mirror 133 can be used as a correction mirror in displaying the real image RI. Therefore, sufficient display quality can be ensured by the second mirror 132 and the third mirror 133, which makes it possible to use a plane mirror simply reflecting the first light beam L1 as the first mirror 131.

Thus, in the configuration for displaying the virtual image VI and the real image RI in an interchangeable manner as depicted in FIG. 5, the third mirror 133 is the concave mirror having the free-form surface, which enlarges and corrects the virtual image VI. The second mirror 132 is also the concave mirror having the free-form surface, similar to the third mirror 133, in order to enlarge and correct the real image RI, but is configured to reflect the first light beam L1 while transmit the second light beam L2. If further improving the display quality of the real image RI is needed, the first mirror 131 is formed as the concave mirror having the free-form surface, so as to enlarge and correct the real image RI. If the display quality of the real image RI is sufficiently ensured by the second mirror 132, the first mirror 131 is formed as the plane mirror and the first optical focus F1 is positioned directly on the first mirror 131, which makes it possible to significantly reduce the size of the first mirror 131.

As described above, the HUD device 1 according to the present embodiment is configured, in addition to the HUD device 1 according to the first embodiment, to further include the second display 12b provided with the second display element, which transmits light emitted from the second light source 11b for virtual image VI and displays the virtual image VI of a display image, wherein the second mirror 132 transmits the second light beam L2 representing the virtual image VI displayed on the second display 12b, wherein the third mirror 133 reflects the second light beam L2 toward the windshield WS, wherein the second display 12b is disposed, along the optical path of the second light beam L2, closer to the opening 17 than the second optical focus F2 of the imaging optical system that includes the windshield WS, the second mirror 132 and the third mirror 133, and wherein the head-up display device 1 allows the virtual image VI of the display image to be visually recognized by the occupant DR. According to the above configuration, it is possible to realize the HUD device 1 that is downsized while highly improving the display quality, and also the HUD device 1 that displays the virtual image VI and the real image RI in an interchangeable manner.

In each of the above-described embodiments, the windshield WS is used as the light-transmissive member. However, a flat glass or a combiner may be used instead.

1. A head-up display device provided with an emission port and emitting display light from the emission port toward a light-transmissive member so as to allow at least a real image of a display image represented by the display light to be visually recognized, the head-up display device comprising:
a first display provided with a first display element, the first display transmitting light emitted from a real-image first light source and displaying the real image of the display image; and
a reflector reflecting at least a first light beam representing the real image displayed on the first display toward the light-transmissive member, the reflector including:
a first mirror reflecting the first light beam toward a second mirror;
the second mirror reflecting the first light beam toward a third mirror; and
the third mirror reflecting the first light beam toward the emission port, wherein
the first mirror is disposed, along an optical path of the first light beam, closer to the emission port than the first display as well as to the first display than a first optical focus of an imaging optical system that includes the light-transmissive member, the second mirror and the third mirror, and wherein
the third mirror and the first display are disposed so that at least a height position of the third mirror is above a height position of the first display.

2. The head-up display device of claim 1, wherein the second mirror is a concave mirror with a free-form surface.

3. The head-up display device of claim 2, wherein the first mirror is a plane mirror, and wherein
the first optical focus is disposed on the first mirror.

4. The head-up display device of claim 2, wherein the first mirror is a concave mirror with a free-form surface, and wherein
the first optical focus is disposed between the first mirror and the second mirror along the optical path of the first light beam.

5. The head-up display device of claim 4, further comprising a second display provided with a second display element, the second display transmitting light emitted from a virtual-image second light source and displaying a virtual image of the display image, wherein
the second mirror transmits a second light beam representing the virtual image displayed on the second display,
the third mirror reflects the second light beam toward the light-transmissive member, and
the second display is disposed, along an optical path of the second light beam, closer to the emission port than a second optical focus of the imaging optical system that includes the light-transmissive member, the second mirror and the third mirror, and wherein
the head-up display device allows the virtual image of the display image to be visually recognized.
